(19) United States
(12) Patent Application Publication
(10) Pub. No.: US 2013/0275230 A1
(43) Pub. Date: Oct. 17, 2013

(54) METHODS AND SYSTEMS FOR TARGETED ADVERTISING BASED ON PASSIVELY COLLECTED SENSOR-DETECTED OFFLINE BEHAVIOR

(71) Applicant: Elbrys Networks, Inc., Portsmouth, NH (US)

(72) Inventors: Benjamin Gibson Sawyer, Freeport, ME (US); Alec Rooney, Eliot, ME (US); Anthony Delli Colli, Exeter, NH (US); James E. Burns, Stratham, NH (US)

(21) Appl. No.: 13/785,272

(22) Filed: Mar. 5, 2013

Related U.S. Application Data
(60) Provisional application No. 61/606,730, filed on Mar. 5, 2012.

(51) Int. Cl. G06Q 30/02

(52) U.S. Cl. CPC G06Q 30/0269
USPC 705/14.66

(57) ABSTRACT

Methods and systems are disclosed for targeted advertising based on passively collected sensor-detected offline user behavior.

### CROSS REFERENCE TO RELATED APPLICATION

This application claims priority from U.S. Provisional Patent Application No. 61/606,730 filed on Mar. 5, 2012 entitled SYSTEMS AND METHODS FOR DEPLOYING OPTIMIZED INTERACTIVE EXPERIENCES AND MANAGING, VALIDATING, AND OPTIMIZING ONLINE REWARDS PROGRAMS WITH USER-GENERATED SENSOR DATA INCLUDING BIOMETRIC DATA, which is hereby incorporated by reference.

### BACKGROUND

The present application relates generally to methods and systems for targeted advertising and, more particularly, to targeted advertising based on passively collected sensor-detected offline behavior.

There are many entities that want to change behavior of individuals and to maintain this change over time. Product and service providers want people to buy their products or services and remain loyal to their brand, healthcare payers want people to obtain and maintain healthy behavior and reduce healthcare costs, energy utilities want people to lead more ‘green’ lifestyles so they do not need to build new power plants, politicians want people to vote for them, charities want people to become habitual donors, etc. These entities have a number of existing techniques for selecting likely candidates to change their behavior and maintain that change.

The entity that wishes to change an individual's behavior can be referred to as the advertiser, and the individual it wishes to change can be referred to as the target. The target that changes its behavior can be referred to as a customer. The advertiser normally delivers a message to the target to make them a customer and then provides incentives to the customer so they remain a customer. The entity that controls the medium through which a target encounters the advertiser's message can be referred to as the publisher. The complexity of the message can range from a single sentence, image, or video to a complex set of instructions, to a software application or game and may include motivators (such as money back, free merchandise, instant rewards, loyalty rewards or generating fear if the viewer fails to act). A campaign is a single concerted effort to turn targets into customers that has a beginning, an end, a message, a monetary budget, and statistics that can be evaluated related to the success rate of creating customers.

Because there is cost associated with delivering messages, advertisers want to minimize the cost per customer created. This determines the efficiency of a campaign.

In advertising, selecting a publisher for an advertiser's message may be done by the advertiser itself or the advertiser may designate a broker. A broker consolidates and categorizes an ‘ad inventory’ and strives to create the most efficient campaign for their advertiser clients and provide a viable business for their publishers. The Ad inventory defines publishers that can deliver the advertiser's message to the target. The ad inventory can be delivered by numerous publishers and may include television shows, web-episodes, print media, search, websites, billboards, software applications, etc. Proper matchmaking between the audience of ad inventory and the target of the advertisement to maximize efficiency of a campaign is the role of the broker. The traditional ad inventory available to brokers has an online context (e.g., search, websites, television, and horizontal applications), active offline context (e.g., coupons), or coarsely targeted offline context (e.g., print media and billboards).

In advertising, attribution validates that a particular publisher played a role in creating customers for a campaign. Today attribution is either direct or statistical. Direct attribution connects the publisher to a behavior change. Some examples are the use of search based advertising when an ad is shown to a user and the user clicks on a link that is unique to the ad. Unique coupons included with an advertisement in a direct mailing or newspaper insert, etc. are another example. In these examples, the customer delivers a piece of information that defines the publisher that got the message to the target. Statistical attribution connects a publisher to a statistically valid change in target behavior (an increase in sales is the most typical example) and broadly applies the efficiency across all publishers that were used during the campaign. Direct attribution allows compensation mechanisms to publishers (and brokers) to be on a performance basis. Validating direct attribution is vital for these compensation mechanisms.

### BRIEF SUMMARY OF THE DISCLOSURE

In accordance with one or more embodiments, a method is provided for targeted advertising based on passively collected sensor-detected offline behavior, comprising the steps, performed by a computer system, of: (a) storing a plurality of advertisements and a target definition associated with each advertisement in a data store; (b) receiving over a network passively collected sensor-detected offline behavior data for each of a plurality of users; (c) generating a sensor profile of each user based on received passively collected sensor-detected offline behavior data for the user; (d) selecting an advertisement from the plurality of advertisements for each user based on the sensor profile of the user and the target definition of the advertisement; and (e) delivering a selected advertisement to each user over a network.

In accordance with one or more further embodiments, a computer system is provided having at least one processor; memory associated with the at least one processor; and a program supported in the memory for targeted advertising based on passively collected sensor-detected offline behavior. The program has a plurality of instructions stored therein which, when executed by the at least one processor, cause the at least one processor to: (a) store a plurality of advertisements and a target definition associated with each advertisement in a data store; (b) receive over a network passively collected sensor-detected offline behavior data for each of a plurality of users; (c) generate a sensor profile of each user based on received passively collected sensor-detected offline behavior data for the user; (d) select an advertisement from the plurality of advertisements for each user based on the sensor profile of the user and the target definition of the advertisement; and (e) deliver a selected advertisement to each user over a network.

In accordance with one or more further embodiments, a computer program product is provided for targeted advertising based on passively collected sensor-detected offline behavior. The computer program product resides on a non-transitory computer readable medium having a plurality of instructions stored thereon which, when executed by a computer processor, cause that computer processor to: (a) store a plurality of advertisements and a target definition associated with each advertisement in a data store; (b) receive over a network passively collected sensor-detected offline behavior data for each of a plurality of users; (c) generate a sensor profile of each user based on received passively collected sensor-detected offline behavior data for the user; (d) select an advertisement from the plurality of advertisements for each user based on the sensor profile of the user and the target definition of the advertisement; and (e) deliver a selected advertisement to each user over a network.

### BRIEF DESCRIPTION OF THE DRAWINGS

FIG. 1 is a simplified diagram illustrating an exemplary network in which a targeted advertising system in accordance with one or more embodiments can be implemented.

FIG. 2 is a simplified diagram illustrating an exemplary targeted advertising process in accordance with one or more embodiments.

### DETAILED DESCRIPTION

Various embodiments disclosed herein are directed to methods and systems for targeted advertising based on passively collected sensor-detected offline behavior. The methods and systems use small, low-cost, wireless sensors and display devices to capture and characterize an individual's offline behavior passively and with fine granularity. This data is used in a brokering method that allows targeting individuals directly based on their passive sensor-detected offline behavior, to validate offline behavior related to reward offers, and to provide direct attribution to publishers that these individuals utilize.

Sensor-detected offline behavior (SDOB) refers to an individual's actions that cause change in the physical world and are passively detected by sensors worn by the individual (e.g., a pedometer), in proximity to the individual (e.g., a motion detector), in machines they own or operate (e.g., an automobile or refrigerator) or with which the individual interacts (e.g., a thermostat). Passively detected means that the individual does not consciously generate information about himself or herself, rather it is gathered as a consequence of the individual's normal offline behaviors.

The sensors can be, e.g., environmental sensors or biometric sensors including, but not limited to, pedometers, heart rate monitors, glucometers, blood pressure monitors, respiration sensors, blood oxymeters, spirometers, thermometers, accelerometers, weight scales, activity monitors, electrocardiograms, electroencephalograms, motion detectors, thermostats, switch sensors, light detectors, microphones, gas sensors, barometers, hygrometers, current sensors, water use meters, gas use meters, flow meters, altimeters, magnetometers, glass break detectors, contact closure detectors, bed use detectors, enuresis sensors, fall detectors, medication dosing sensors, water sensors, smoke sensors, property exit sensors, CO sensors, personal emergency response sensors, and usage sensors.

Sensor-detected offline behavior is separate and distinct from both online behavior and active behavior. Active behavior detection is defined as an additional behavior the individual undertakes that is outside of their normal behavior that allows the detection of their behavior. Examples of active detection include coupon redemption. Online behavior is defined as an individual's actions that cause change in the virtual world of a network such as the Internet and is determined based on tracking a user's input into a computer program (such as a web browser or mobile phone application). A common example of active online behavior used for brokering of advertisements to end-users is Google Ad Words. Passive offline behavior used for brokering of advertisements is separate and distinct from this.

The methods and systems disclosed herein use SBOD to target advertisements from advertisers to individuals likely to become customers via publishers. The methods and systems feature passive collection of offline behavior from sensors, the association of the collected sensor data to an individual, the categorization of the individual based on offline behavior, the matchmaking between individuals and advertisers, the auction methodology used to manage the number of advertisers messages delivered to an individual within a given time frame, the delivery of an advertiser's message and optional challenge to an individual via publishers, the tracking of a challenge via SBOD, the delivery of the reward from advertiser to an individual, and the attribution of customer acquisition (or maintenance) to publishers.

For example, a healthcare payer can target pre-diabetic individuals with a reward of $1 off their premium for each week that they produce more than 20,000 steps. A sports drink manufacturer can target individuals who just played a tennis match with a reward of their new sports drink. A heating oil provider can target individuals with low efficiency furnaces with a $20 rebate from their company if they improve the furnace efficiency by 10%. A weight loss service can target individuals whose weight has recently gone down and is creeping back up with a reward of 20% off a supply of their product if the individual can lose 2 pounds over the next week.

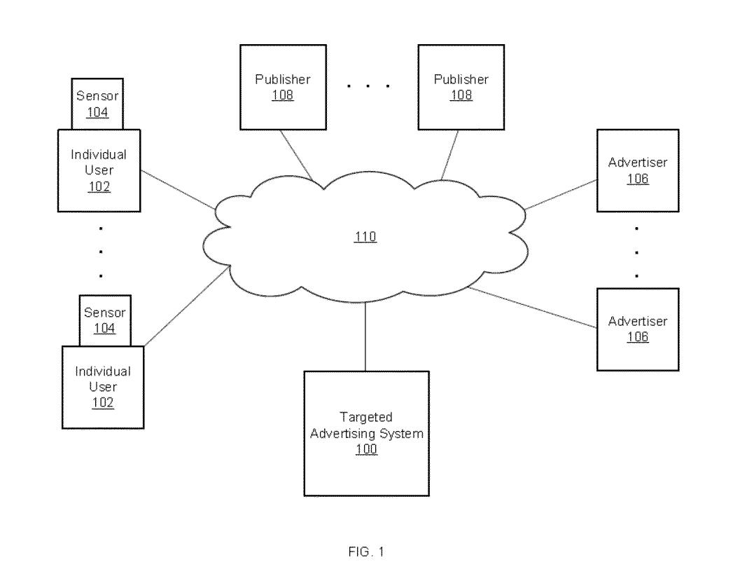

FIG. 1 illustrates an exemplary network, in which a targeted advertising system 100 in accordance with one or more embodiments may be implemented. The targeted advertising system 100 is preferably implemented in a computer server system, which communicates with client devices operated by the users of the system 100, including individual users 102 (for whom sensor-detected offline behavior data is received from associated sensors 104), advertisers 106 (business entities spending money to have a message delivered to an individual user), and publishers 108 (business entities having an ad inventory that can carry an advertiser's message to an individual user). The client devices communicate with the system 100 over a communications network 110. Sensor data is provided by the sensors to the system 100 over the network 110 through a sensor data collection process (described in further detail below). The communications network 110 may comprise any network or combination of networks including, without limitation, the Internet, a local area network, a wide area network, a wireless network, and a cellular network. The client devices can comprise generally any computing device that can communicate with the computer server system including, without limitation, personal computers (including desktop, notebook, and tablet computers), smart phones, tablets and cell phones.

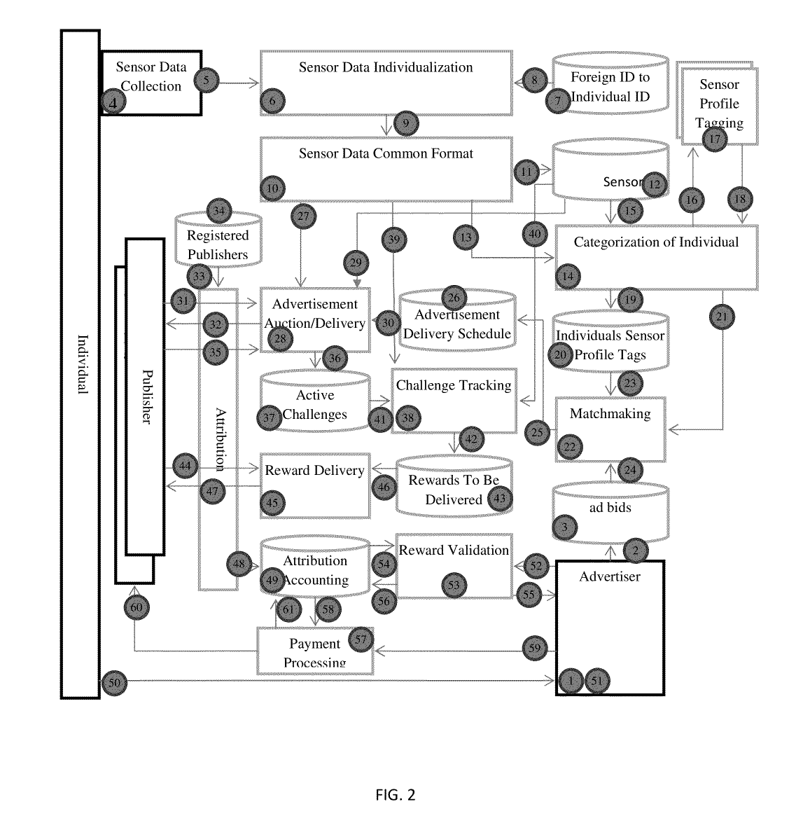

FIG. 2 schematically illustrates an exemplary targeted advertising process in accordance with one or more embodiments. The numbering used in the description below corresponds to reference numbering for elements and processes in the figure.

Individual users, publishers, and advertisers initially register with the targeted advertising system. Individual users register their sensor data collection systems. Sensors used by individual users are identified by the system with a unique identifier.

1. An advertiser is an external entity that desires to have advertisements delivered to individual users.

2. The advertiser can set or modify ad bids. The advertiser may directly or through a designated third party define, redefine, or disable their advertisements to the system. The delivery of the ad bid creation or alteration may be via a web page, a phone call or any other means of communication that allows the transfer of human readable data.

3. The Ad bids data store is a data store containing all active ad bids. Each ad bid defines the following pieces of information: Ad bid identifier, advertiser identifier, advertiser payment mechanism, target(s) definition, daily budget, target payment metric, max cost per payment metric, and advertisement definition.

The Ad bid identifier is a unique identifier for the specified bid. It is generated by the system.

The Advertiser identifier is a unique identifier for the entity that placed the ad bid. It is generated by the system.

The Advertiser payment mechanism is information defining how payment will be obtained from the advertiser upon successful execution of the ad bid terms. Examples include credit card information, a billing address, PayPal, etc.

The Target(s) definition is a list of target definitions for an advertisement. Each target definition describes a search set for individuals that the advertiser desires to receive the advertisement. Each target definition comprises a set of tuples. Each tuple has a specified form (sensor profile tag, minimum probability). The sensor profile tag defines an attribute of a target Individual while the minimum probability defines the minimum desired accuracy of the sensor profile tag. Not all sensor profile tags will offer 100% assurance and instead offer probability of the sensor profile tag applying to the individual The tags available are constrained to a finite set of unique identifiers generated by sensor profile tagging (17) routines. Some examples of target definitions are Target 1: (Pre-diabetic, 80%), (Gaining-weight, 100%) and Target 2: (Overweight, 80%), (Lightly-Active, 100%).

The Daily budget is a monetary sum that defines the maximum amount of money the advertiser is willing to spend each day that their ad-bid is active.

The Target payment metric specifies what the advertiser will pay for, including per number of displays (e.g., per 1000 displays), challenge acceptance, challenge completion, and acquisition. Challenge acceptance refers to a challenge associated with the advertisement that is accepted by an individual. Challenges can be tracked based on sensor detected offline behavior. Challenge completion refers to challenges completed by an individual based on sensor detected offline behavior. Acquisition refers to a collection of a reward associated with the challenge by an Individual.

The Max cost per payment metric represents the maximum amount the advertiser is willing to pay for their target payment metric.

The Advertisement definition specifies the advertisement to be delivered to a target individual. The advertisement definition includes the advertisement content, advertisement delivery time, and optionally challenge definition.

The Advertisement content refers to the content to be displayed to target individual. This can be a constrained subset of HTML that can be displayed within a constrained window size of a publisher.

The Advertisement delivery time can be defined by an advertiser to have an advertisement delivered relative to the occurrence of an offline behavior. If this is not defined then the system will deliver at any time that becomes available. If this attribute is defined then it comprises a list of one or more off line event definitions. Event definitions are triggered by arrival of new sensor data. Each offline event definition includes an offline event identifier, a target sensor type, a target sensor condition, and a maximum delivery timeframe.

The Offline event identifier is a unique identifier created by the system.

The Target sensor type specifies the sensor data type that triggers the delivery of the advertisement. This is chosen from a finite enumeration of sensor types, e.g., steps, blood pressure, thermostat, door open/close, and outlet on/off.

The Target sensor condition specifies what action will trigger delivery of the advertisement relative to the target sensor type. The condition can be defined as a Boolean of the form: <comparator><value>. The <comparator> may be chosen from a finite list including <, <=, >, >=, =, < > and member-of. The <value> must match the sensor type and units. The “member-of” comparator will return true if the value from the target sensor matches any of a list of values. In addition <value> may be replaced with a special placeholder: <previous-value>. <previous-value> is the value just prior to the newly acquired target sensor value. If the advertiser wants the advertisement delivered when any new value for target sensor type appears then it may leave the target sensor condition blank.

The Maximum delivery timeframe specifies the maximum number of minutes that may pass between the target sensor condition occurring (based on end-time of the sensor data value in common data format) and the delivery of the advertisement.

The Challenge definition defines an offline behavior goal for the Individual. The system tracks the offline behavior of individuals to determine if they achieve the goal. The challenge definition to include challenge description, challenge start, challenge duration, and challenge goals.

The Challenge description is a description to motivate an individual to join the challenge. This is a constrained subset of HTML that can be displayed with a constrained window size of a publisher.

The Challenge start defines when the challenge begins. The challenge may be relative or absolute. A challenge start of type ‘absolute’ indicates that it begins on the day the ad bid was placed into the system. A ‘relative’ start indicates that the challenge begins when the Individual accepts the challenge. A relative challenge start is useful for challenges of the sort: “walk 20,000 steps in the next week”. An absolute challenge start is useful for challenges of the sort: “get your weight to 200 kilograms by the end of February”.

Challenge duration specifies a time period, e.g., the number of hours, the individual has to complete the challenge. This duration is either from the start of the advertisement (absolute challenge start) or the acceptance by the individual (relative challenge start).

Challenge goals comprises a list of goal n-tuples. Each n-tuple takes the form (sensor metric, comparison period, accumulator, comparator, scope, target value). The Sensor metric is a metric type for the challenge. Examples include steps, blood pressure, weight, ambient temperature, and miles-per-gallon. The Comparison period specifies the number of minutes between comparisons of the sensor metric to the target value.

During the comparison period it is likely that more than one value for the sensor metric has been collected by the sensor, the accumulator defines how to combine/select the value from the list of sensor values collected during the comparison period. Options include: last value, lowest value, highest value, summation and average. For example, if the comparison period is 1 day and the sensor metric is steps then a summation accumulator adds all the steps collected during the day providing the total steps per day. If the comparison period is 1 week and the sensor metric is weight then an accumulator of average sums all the weights and divide by the number of weight values collected during the comparison period and provides the average.

The Comparator is selected from the set of >, >=, <, <=, =.

The Scope defines whether the comparison is relative or absolute. A relative comparator compares the target value to the change in the sensor metric from the beginning of the challenge. So, the value compared with the sensor metric value closest to the acceptance of the challenge minus the sensor metric over the comparison period accumulated by accumulator. A relative comparator is good for challenges of the sort that state “lose 3 kilograms”. An absolute comparator compares the sensor metric value directly to the target value. An absolute comparator is good for challenges of the sort that state “take 20,000 steps”.

The Target value is either the target delta between the sensor metric at start of challenge or the target value for the sensor metric.

The Challenge Reward Description is a description of the reward to be provided by the advertiser if the challenge goal is achieved. This is a constrained subset of HTML that can be displayed with a constrained window size of a publisher.

4. Sensor data collection is an external process that collects sensor data from the individual or the environment around the individual or property for which the individual is the owner, caretaker, or operator and makes it available to the targeted advertising system. There are numerous possible mechanisms that can provide sensor data collection. In all cases they begin with a sensor device that detects changes in the physical world and generates electronic information to represent them. The sensors may be worn (e.g., a pedometer or a heart rate monitor), carried (e.g., a glucometer or a blood pressure monitor), installed inside devices (e.g., an automobile or a dishwasher) or be installed on property (e.g., a motion sensor or a smoke detector). The electronic data generated by the sensor devices can be grouped by the type of information collected. For example, pedometers collect steps, thermostats collect temperature, light sensors collect luminosity, water sensors collect a Boolean indicating presence or absence of water. Making the sensor data available to the system may be done directly or indirectly. A direct process may be from the sensor device (if it is Internet Protocol enabled) or from a gateway device. Examples of direct processes include Continua Bluetooth devices, Bluetooth Low Energy devices, ANT+devices, ZigBee devices and Z-Wave devices. The data from the sensor is transported over the Internet directly to the system using a protocol defined by the sensor data collection provider. An indirect process collects the sensor data, transmits it over the Internet, stores it in a web service, and makes the sensor data available to the system via a protocol defined by the sensor data collection provider. Examples of indirect processes include FitBit or BodyMedia. Data delivered from the sensor data collection mechanism will include a unique identifier to represent either the sensor device (in the direct mechanism) or the Individual. A sensor device may possess a globally unique identifier, such as an Extended Unique Identifier (EUI-64) from the IEEE or one can be created for each sensor device by combining its manufacturer, model and a unique identifier (serial number) within the scope of the manufacturer and model. An indirect sensor data collection service will provide a unique identifier for the Individual that owns the data collected.

5. The Obtain sensor data mechanism receives or collects sensor data from the sensor data collection (4) processes. The data includes the sensor data and the unique identifier.

6. Sensor data individualization is an internal process that connects an internal (native) Individual identifier with a received set of sensor data. The process assumes sensor data is received from a sensor data collection (4) with a foreign unique identifier. This will either be a unique sensor device identifier or a unique identifier for the Individual in the sensor data collection (4) process. The process executes any time new sensor data is available from a sensor data collection (4). The process can utilize the following algorithm:

6.1 Obtain sensor data from sensor data collection process (4).

6.2 Look up the native Individual identifier in the foreign ID to individual ID (7) data store using the sensor data collection (4) identifier and the foreign identifier provided.

6.3 Deliver the sensor data along with its native Individual identifier to the Sensor Data Common Format (10) process.

7. The Foreign ID to individual ID data store is created by users opting in to the system and registering their sensor data collection systems. During registration the system creates a native unique identifier for each individual. For each registration by the individual, another tuple is added to the data store. This data store comprises records that include the following information: a sensor data collection (4) identifier (a unique identifier for the sensor data collection (4)), a foreign unique identifier (a unique identifier for the sensor or individual for the sensor data collection), and a Native individual identifier (native identifier for the Individual within the method).

8. Get individual ID from foreign ID is a look up request providing a sensor data collection (4) source, a foreign ID and receiving a native unique individual identifier in return.

9. Raw sensor data transfer with individual ID: Once data from a sensor data collection (4) has been associated with an Individual's native unique identifier, the sensor data and that Individual's identifier are delivered to the sensor data common format (10) process.

10. Sensor devices from different manufacturers and models may utilize different data formats to represent the sensor data. This makes all other processes that require accessing the sensor data more complex because they need conditional code paths for each different sensor data format. The Sensor Data Common Format process translates the different formats into a single common data format that captures the salient data from the original. The common data format defines common units and time stamps (e.g., Greenwich Mean Time). Salient attributes in the common data format:
“collector”—the device providing the data. The unique sensor identifier.
“metricId”—a unique identifier for the sensor data collection event. Sensor data is often collected by Sensor Data Collection, stored over a period of time and then delivered as a single batch of data. This identifier is associated with the batch received from the Sensor Data Collection.
“metricType”—type of the metric. This is chosen from a finite enumeration. Examples can include steps and blood pressure.
“operator”—who operated the device to obtain the reading. A unique individual identifier, defaults to sensor owner.
“startTime”—when did the sample period for this batch of data start (GMT)
“endTime”—when did the sample period for this batch of data end (GMT)
“data”—A list of n-tuples for each sensor data value collected during the sample period for this batch of data. Each n-tuple in the list includes startTime (the start of sample period for value), endTime (the end of the sample period for value), and value (the electronic data representing the physical world attribute sensed).
“profileAccumulator”—if there were multiple readings how were they combined (chosen from a finite enumeration including sum, avg, native)
“profileName”—what is the format of the returned data (defines how the values in data field are interpreted, e.g., for blood pressure the profile indicates the data is in pairs and the first number of each pair is the systolic value and the second number in each pair is the diastolic value)
“profileUnits”—what are the units of the metric (chosen from a finite enumeration).

11. Store sensor data: Once sensor data is associated with a native individual identifier and converted to a common data format, it is stored in the Sensor history per Individual (12) data store.

12. Sensor history per Individual is stored in a data store with records for every sensor data collection for every opted-in individual in Sensor Data Common Format. Each record includes an Individual identifier (unique identifier for the Individual to which the sensor data applies) and Sensor data (see Sensor Data Common Format (10)).

13. Notification of new data: When new data is stored into the Sensor history per Individual (12), a notification is sent to the Categorization of Individual (14) process indicating new data is available. This notification includes the Individuals unique identifier.

14. The Categorization of Individual process executes any time a new individual is added to the system, a new Sensor Profile Tagging (17) routine is ______, a Notification of New Data (13) is received or a Sensor Profile Tagging (17) routine's reevaluation time is due. The process manages the sensor profile tags that are associated with Individual unique identifiers. When executed it utilizes the following process:

14.1. Set target Individuals to nil.

14.2 Set target sensor profile tagging routines to all.

14.3 If executing because a new individual was added set target individuals to the new individual and target sensor profile tagging routines to all.

14.4 Else if executing because a Notification of New Data from an individual, d, then set target individuals to d and sensor profile tagging routines to all.

14.5 Else if executing because a new sensor profile tagging (17) routine was introduced then set the new sensor profile tagging routine as the target sensor profile tagging routine and set the target individuals to all individuals.

14.6. Else if executing because a sensor profile tagging (17) routine's reevaluation time is due then remove the sensor tags associated with the sensor profile tagging (17) routine from all individuals, set target individuals to all, set target sensor profile tagging routines to the sensor profile tagging routine whose reevaluation time is due, reset its reevaluation time to 1 day in the future.

14.7 For each target individual, I:

14.7.1 For each target sensor profile tagging routine, S:

14.7.1.1 If sensor type requirements of S are met by the individual add the tuple (I,S) to matching sensor profile tagging routines

14.8 For each matching sensor profile tagging routine, (I,S):

14.8.1 Get sensor data from 1 as required by S

14.8.2 Send sensor data to S

14.8.3 If S returns more than zero sensor tags, update the Individual's sensor tags in Individuals sensor profile tags data store.

15. Get sensor data for individual: When the categorization of individual (14) process determines it needs to carry out sensor profile tagging, it will get sensor data history for one or more individuals.

16. Send individual sensor data: When the categorization of individual (14) process determines that a Sensor Profile Tagging (17) routine is to be executed it will deliver the required sensor data history of the required sensor data types to the Sensor Profile Tagging (17) routine.

17. Sensor profile tagging: A process that returns zero or more sensor tags that applies to a set of historical sensor data. This routine executes when it is provided with sensor data in the common format. Every sensor profile tagging routine has a descriptor that defines its requirements to determine sensor tags. The descriptor includes information on sensor data type and required time range. The sensor data type is a list of sensor data types that it requires. These are chosen from a finite list including, e.g., steps, ambient temperature, blood pressure, weight, door open/close, switch on/off. The Required time range is a number of minutes of data it requires. This determines the amount of historical data that is required in order for this sensor profile tagging routine to provide its response.

Each sensor profile tagging routine will carry out this process:

17.2.1. Evaluate the sensor data provided to it

17.2.2. Return an empty list or a list with one or more tuples where each tuple is (<sensor profile tag>, <accuracy probability>).

18. Send sensor profile tags: A list of zero or more sensor profile tag tuples defining sensor profile tags and probabilities. The categorization of Individual (14) process will connect these sensor tags with an individual identifier.

19. Store individual ID, sensor profile tags: The categorization of Individual (14) process upon receiving greater than zero sensor tag tuples from sensor profile tagging (17) routine will store the association between the individual and the sensor profile tags.

20. Individual's sensor profile tags: A data store that associates sensor profile tags to Individual's identifiers. Each record has an Individual ID (an identifier for the Individual) and a Sensor profile tag tuples (a list of sensor tag tuples: (<sensor tag>, <probability>)).

21. Notification of updated categorization of individuals: When an Individual's sensor profile tags are added or updated a notification is delivered to the matchmaking (22) process. The notification includes the sensor tags that were added/altered.

22. Matchmaking: This process matches ad bids to Individuals. It takes into account sensor tags, but also the individual's required sensor devices for advertisement challenge. It executes when a new ad-bid is introduced or an update to the individual's sensor profile tags (20) data store occurs. It uses a process as follows:

22.1. Determine deprecated ad-bids. If an update to the Individuals sensor profile tags data store has occurred, it may be that sensor tags were removed from an Individual. If this is the case:

22.1.1. Obtain all ad-bids in the advertisement delivery schedule (26) that have that individual as a target and have the removed sensor tag(s) as part of their target description. Remove these ad-bids from the advertisement delivery schedule (26).

22.2. Determine new ad-bids to schedule.

22.2.1. Obtain the ad-bids to process. In the case of new ad-bids this will be those that are new. In the case of an update to the Individuals Sensor Profile Tags data store it will be those ad-bids that include the updated sensor-tags in their target definition.

22.2.2. For each ad-bid:

22.2.2.1. Obtain the individuals that meet the ad-bid target definition (both sensor tags and required sensor types for optional delivery time and optional challenge validation). Add tuples of (ad-bid id, individual id, delivery-time-type) to the advertisement delivery schedule (26). Deliver-time-type is either empty (indicating it can be delivered ‘any time’) or the sensor type associated with the ad-bid's delivery time.

23. Get individuals with sensor tags: The matchmaking (22) process will search for individuals that have specific sensor tags.

24. Get ad bids: The matchmaking (22) process will search for ad bids that are new or that have a target definition that includes sensor tags that have recently changed in the individual's sensor profile tags (20).

25. Update active advertisements: The matchmaking (22) process will add/remove tuples of (ad-bid id, individual id, delivery-time-type) to the advertisement delivery schedule (26) based on ad-bids available and the sensor tags associated with individuals. Deliver-time-type is either empty (indicating it can be delivered ‘any time’) or the sensor type associated with the ad-bid's delivery time.

26. Advertisement delivery schedule: This data store maintains tuples defining all the ad-bids waiting for delivery. Entries include the following information: Ad-bid identifier (a unique identifier for the ad-bid), individual identifier (a unique identifier for an individual that has sensor tags and sensor types needed for ad-bid) and Delivery sensor data type (<empty> if any time, otherwise sensor data type).

27. Notification of new data: When new data is stored into the sensor history per individual (12), a notification is delivered to the advertisement auction/delivery (28).

28. Advertisement auction/delivery: This process runs as long as there are active publishers. It has a number of processes that run. One is triggered by notification of new data (27), while the other is triggered by time.

28.1. When notification of new data (27) is received, obtain the updated sensor data for the indicated Individual(s) from the sensor history per individual (12).

28.1.1. Get ad-bids that are match-made with the individual(s) and have a delivery schedule that have target sensor type that match the new sensor data.

28.1.2. For each of these ad-bids

28.1.2.1. Compare the ad-bid's target sensor condition to the individual's new sensor data, if they match add them to a list of potential ad-bids.

28.1.3. For each ad-bid in the potential ad-bids list:

28.1.3.1. Add them to the delivery-time-activated list of ad-bids for the Individual's unique identifier.

28.1.3.2. Start a timer for <now>+ad-bid's maximum delivery timeframe. When the timer triggers it will run a process that will remove the ad-bid from delivery-time-activated list for the Individual.

28.2. Every 60 seconds:

28.2.1. Create the publishers-awaiting-deliver list by getting a list of active publishers that have not had an advertisement update in 60 seconds.

28.2.2. For each publisher in the publisher-awaiting-delivery list:

28.2.2.1. Get the Individual's unique identifier that is associated with that instance of the publisher

28.2.2.2. Get the delivery-time-activated list of ad-bids for this Individual and add in the ad-bids for this individual that can be delivered any time.

28.2.2.3. Filter out ad-bids that have met or exceeded their daily budget.

28.2.2.4. For each ad-bid remaining:

28.2.2.4.1. Calculate its rank by: Max cost per payment metric/number of impressions/average days till payment metric achieved. For ad-bids without history the days till payment metric achieved is assumed to be 1. For ad-bids that do not have a number of impressions it is set to 1.

28.2.2.5. Sort the list by rank.

28.2.2.6. Select the most highly ranked ad-bid

28.2.2.7. Obtain the max cost per payment metric for the ad-bid ranked immediately below the most highly ranked. If there is none then set it to a pre-determined default value. Add one penny to this value. This is the cost of this advertisement, store this cost

28.2.2.8. Deliver the advertisement description to the publisher. If the advertisement's target payment metric is per impressions (number of displays) then increment the number of displays.

28.2.2.9. If the target payment metric is met then subtract the cost of this advertisement from the ad-bids current daily budget.

29. Get Individual's sensor data: When a notification of new data (27) arrives, the advertisement auction/delivery (26) process retrieves the changes to that individual's sensor data in order to determine updated ad-bids available for auction.

30. Get scheduled advertisements: When determining ad-bids available for auction advertisement auction/delivery (26) process retrieves ad-bids from the advertisement delivery schedule (26) data store.

31. Notification of publisher change: When an instance of a registered publisher becomes active or inactive, a notification is delivered from the publisher to the system. The notification includes the Individual's identifier as well as the publisher's identifier.

The system authenticates the publisher's identity with its registered publishers (34) data store. The advertisement auction/delivery (26) process uses this to determine the Individuals available to have advertisements presented to them and provide attribution to the advertiser. This guides the ad-bids available for auction and where to deliver the advertisement.

32. Deliver advertisement and attribution audit: The advertisement auction/delivery (26) process upon completing an auction for an Individual delivers the advertisement's description to the publisher for display to the Individual. If the publisher acknowledges the display of the advertisement, then this process updates the attribution accounting data store with an entry indicating that the publisher (unique id) displayed the advertisement associated with ad-bid (unique id) to Individual (unique id) with an auction bid (monetary sum).

33. Get publisher identifiers: When a publisher communicates with the system, it utilizes a unique identifier it received when it was registered with the system. During communication, the Attribution process retrieves information about the publisher in order to validate its identity to ensure that the correct publisher receives attribution.

34. Registered publishers: A data store of publishers that have registered with the system. Each registered publisher has a record of information including Publisher Identifier (a unique identifier created by the system) and Publisher Secret (a shared secret created by the system).

35. Opt-in to advertisement: An Individual who sees an advertisement in from a publisher may opt-in to an associated Challenge. The Attribution process updates the attribution accounting (49) data store with an entry indicating that Individual (unique ID) opted-in to the challenge associated with ad-bid (unique ID) via the publisher (unique ID).

36. Store new active challenge: Upon receiving an opt-in to an ad-bid's challenge, the advertisement auction/delivery (28) stores the challenge as active for the Individual. In addition it removes the ad-bid for this individual from the advertisement delivery schedule (26).

37. Active challenges: This data store contains all of the currently active challenges. Each challenge in the data store includes the following information: Individual Identifier (the identifier for the individual that is actively pursuing the challenge), Publisher Identifier (the identifier for the publisher through which the Individual opted-in to the challenge), Start Time (the date and time that the challenge was begun by the Individual), and Sensor data accumulators (a set of the Individual's sensor data that matches the goal of the challenge collected and accumulated during the period of the challenge).

38. Challenge tracking: This process tracks the progress of Individuals towards the goals of the challenges they have opted-in to. The process executes on a timer if no notification of new data (40) arrives in five minutes. Otherwise, it executes when notification of new data (40) arrives. The process is as follows:

38.1. If notification of new data arrives for an Individual

38.1.1. Retrieve the updated sensor data for the Individual

38.1.2. Update their active challenge data

38.1.3. Compare the updated challenge data for the Individual to the challenge's goals.

If they are met then add the ad-bid and Individual to the rewards to be delivered data store.

38.2. If notification of new data or woken by timer

38.2.1. Retrieve all challenges with challenge duration that ended and remove them from the active challenges data store. Update the attribution accounting data store with a record indicating Individual (unique id) failed the challenge associated with ad-bid (unique id).

38.2.2. Reset the timer to wake the process in 5 minutes.

39. Notification of new data: This occurs when new sensor data is available a notification is delivered to the challenge tracking (38) process so that it may update the active challenges (37) status.

40. Get Sensor Data For Individual: When the Challenge Tracking process receives a Notification of new data it retrieves the new data for the Individual so that it may update the challenge status for that Individual.

41. Get active challenges: When the Challenge Tracking process is determining challenge status it retrieves the challenges current status from the Active Challenges data store.

42. Store new reward to be delivered: When the challenge tracking (38) process determines that an Individual has achieved the challenges goals then the ad-bid and Individual's identifier are stored in the rewards to be delivered (43) data store.

43. Rewards to be delivered: This data store contains the information for rewards to be delivered to Individuals. Each reward to be delivered includes: Individual ID (a unique identifier for the Individual to receive the reward) and Ad-bid ID (a unique identifier for the Ad-bid defining the reward to be delivered).

44. Notification of publisher change: When a registered publisher has an instance that becomes active or inactive, a notification is delivered from the publisher to the system. The notification includes the Individual's identifier for the individual running the instance of the publisher as well as the publisher's identifier. The system authenticates the publisher's identity with its registered publisher's data store. The reward delivery (45) process uses this to determine who to alert about their reward.

45. Reward delivery: This process executes when a notification of publisher change (44) occurs. It executes according to the following process:

45.1. Obtain the Individual's identifier

45.2. Get rewards pending for this Individual's identifier

45.3. For each reward pending

45.3.1. Create a unique reward identifier by SHA256 hashing the Individual Identifier, Application Identifier and ad-bid identifier along with a randomly generated number that is the unique reward secret.

45.4. Deliver reward notice and unique reward identifier to publisher for viewing by Individual.

46. Get rewards to be delivered: The reward delivery (45) process retrieves the rewards available for delivery for particular Individuals.

47. Deliver reward and attribution audit: The reward delivery (45) process delivers reward notifications to Individuals via a publisher. During this process it will also update the attribution accounting (49) data store with an entry indicating that Individual (unique ID) received a reward (unique reward identifier and secret) to the challenge associated with ad-bid (unique ID) via the publisher (unique ID).

48. Store attribution accounting: At various stages of advertisement and challenge processing attribution accounting (49) data store is updated.

49. Attribution accounting: This data store maintains all interactions with Individual related to specific ad-bids via specific publishers. Each entry in the data store includes:

49.1. Individual Id: unique identifier for the associated Individual.

49.2. Ad bid Id: unique identifier for the associated ad-bid.

49.3. Activity: indicates a stage of advertisement life cycle with associated extra data:

49.3.1. View: Advertisement delivered for viewing. Includes publisher Id.

49.3.2. Opt-in: Advertisement had associated challenge and Individual has opted in to the challenge. Includes publisher ID.

49.3.3. Challenge failed: Individual did not achieve challenge goals before challenge ended.

49.3.4. Challenge succeeded, Reward delivered: Individual achieved challenge and received reward. Includes publisher ID, Reward unique ID and the randomly generated number used to create unique reward identifier.

49.3.5. Reward redeemed: Individual has redeemed their reward for successfully completing the challenge. Includes reward unique ID.

50. Get reward: An Individual may redeem their reward through many channels. But in order to receive it, they will present the unique reward identifier to the Advertiser.

51. Process reward (an external process): The advertiser, in order to prevent fraud and obtain marketing data on the Individual, processes the reward identifier. It delivers the identifier to the system for validation. It will accept the result of this validation. If the result is valid then it will also accept a set of information associated with this advertisement, namely all attribution records associated with it (minus the Individual's identifier) and all sensor data records used by the Challenge Tracking process.

52. Request reward validation: Advertiser presents a reward identifier for validation to the system.

53. Reward validation: This process validates that reward identifier is for a pending reward. The process is:

53.1. retrieve the attribution record associated with the reward identifier

53.2. If it does not exist indicate an invalid reward

53.3. Else if it does exist

53.3.1. update the attribution accounting (49) data store to indicate the reward has been redeemed.

53.3.2. indicate to the Advertiser the validity of the reward.

53.3.3. Retrieve all records related to the reward from the attribution accounting (49) data store remove individual identifiers and provide to the Advertiser.

53.3.4. Retrieve all sensor data in the reward tracking record in active challenges (37), remove Individual identifiers and provide to the Advertiser.

54. Get attribution accounting: While validating a reward identifier the reward validation (53) process retrieves the attribution accounting associated with that reward identifier.

55. Send reward validation and marketing data: When the reward validation (53) process validates a reward identifier it delivers all entries in the attribution accounting (49) data store related to the advertisement to the individual. When these are delivered the Individual identifier is removed from them. In addition, all sensor data utilized by the challenge tracking process is delivered to the advertiser.

56. Set attribution for valid reward: When the reward validation (43) process validates a reward identifier and has delivered it to the advertiser, it adds an entry to the attribution accounting (49) data store indicating that Individual (unique ID) redeemed a reward (unique reward identifier and secret) to the challenge associated with ad-bid (unique ID).

57. Process payments: This process runs on a timer. It executes the following process:

57.1. Retrieve all attribution accounting records indicating that the target payment metric has been met but not paid.

57.2. For each attribution accounting record waiting for payment

57.2.1. Extract funds from the ad-bids advertiser account into the system's account.

57.2.2. Transfer funds to publisher(s) according to contracts with each publisher.

57.2.3. Add an entry in the attribution accounting (49) data store that payment (amount) from Advertiser (unique ID) received on (date) for delivery of ad-bid (unique ID) to individual (unique ID).

57.2.4. Add an entry in the attribution accounting (49) data store that payment (amount) to Publisher (unique ID) sent on (date) for delivery of ad-bid (unique ID) for individual (unique ID).

58. Get attribution accounting for application: The Payment Processing gets all advertisements that have not yet been paid.

59. Extract payment from Advertiser/Publisher: Transfer funds from advertiser (utilizing ad-bid payment mechanism) to system's account.

60. Pay application producer: Transfer funds from the system's account to Viewer Application's accounts.

61. Indicate payment: The payment processing (57) will update the attribution account data store with entries indicating payments.

The processes of the targeted advertising system described above may be implemented in software, hardware, firmware, or any combination thereof. The processes are preferably implemented in one or more computer programs executing on a programmable computer (which can be part of the server computer system) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A method for targeted advertising based on passively collected sensor-detected offline behavior, comprising the steps, performed by a computer system, of:
(a) storing a plurality of advertisements and a target definition associated with each advertisement in a data store;
(b) receiving over a network passively collected sensor-detected offline behavior data for each of a plurality of users;
(c) generating a sensor profile of each user based on received passively collected sensor-detected offline behavior data for the user;
(d) selecting an advertisement from the plurality of advertisements for each user based on the sensor profile of the user and the target definition of the advertisement; and
(e) delivering a selected advertisement to each user over a network.

2. The method of claim 1, wherein the plurality of advertisements are from a plurality of advertisers and the method further comprises receiving bids from the advertisers for delivery of advertisements to users having particular sensor profiles, and selecting advertisements based on the bids.

3. The method of claim 1, further comprising receiving online behavior data for each user, and wherein step (d) further comprises selecting an advertisement for each user based on the online behavior data for the user.

4. The method of claim 1, wherein step (e) comprises delivering an advertisement to a user at a given time based on detected sensor-based offline behavior of the user.

5. The method of claim 1, wherein at least some of the advertisements are associated with a challenge for a user having an offline behavior goal.

6. The method of claim 5, further comprising validating achievement of the challenge by a user based on passively collected sensor-detected offline behavior data received for the user.

7. The method of claim 6, further comprising receiving payment from an advertiser for an achieved challenge and delivering a reward to a user completing a challenge.

8. The method of claim 1, wherein step (e) comprises selectively providing advertisements to a publisher for transmission to each user.

9. The method of claim 8, further compromising receiving payment from an advertiser and making payment to one or more publishers to which transmission of an advertisement to each user is attributable.

10. The method of claim 1, wherein each target definition for an advertisement comprises one or more tuples, each tuple comprising a sensor profile tag defining an attribute of the user and probability data indicating a desired accuracy of the sensor profile tag.

11. The method of claim 1, wherein the passively collected sensor-detected offline behavior data is received from an environmental sensor or a biometric sensor.

12. The method of claim 1, wherein the passively collected sensor-detected offline behavior data is received from a pedometer, a heart rate monitor, a glucometer, a blood pressure monitor, a respiration sensor, a blood oxymeter, a spirometer, a thermometer, an accelerometer, a weight scale, an activity monitor, an electrocardiogram, an electroencephalogram, a motion detector, a thermostat, a switch sensor, a light detector, a microphone, a gas sensor, a barometer, a hygrometer, a current sensor, a water use meter, a gas use meter, a flow meter, an altimeter, a magnetometer, a glass break detector, a contact closure detector, a bed use detector, enuresis sensor, a fall detector, a medication dosing sensor, a water sensor, a smoke sensor, a property exit sensor, a CO sensor, a personal emergency response sensor, or a usage sensor.

13. A computer system, comprising:
at least one processor;
memory associated with the at least one processor; and
a program supported in the memory for targeted advertising based on passively collected sensor-detected offline behavior, the program having a plurality of instructions stored therein which, when executed by the at least one processor, cause the at least one processor to:
(a) store a plurality of advertisements and a target definition associated with each advertisement in a data store;
(b) receive over a network passively collected sensor-detected offline behavior data for each of a plurality of users;
(c) generate a sensor profile of each user based on received passively collected sensor-detected offline behavior data for the user;
(d) select an advertisement from the plurality of advertisements for each user based on the sensor profile of the user and the target definition of the advertisement; and
(e) deliver a selected advertisement to each user over a network.

14. The system of claim 13, wherein the plurality of advertisements are from a plurality of advertisers and the program further causes the at least one processor to receive bids from the advertisers for delivery of advertisements to users having particular sensor profiles, and select advertisements based on the bids.

15. The system of claim 13, wherein the program further causes the at least one processor to receive online behavior data for each user, and wherein (d) further comprises select an advertisement for each user based on the online behavior data for the user.

16. The system of claim 13, wherein (e) comprises deliver an advertisement to a user at a given time based on detected sensor-based offline behavior of the user.

17. The system of claim 13, wherein at least some of the advertisements are associated with a challenge for a user having an offline behavior goal.

18. The system of claim 17, wherein the program further causes the at least one processor to validate achievement of the challenge by a user based on passively collected sensor-detected offline behavior data received for the user.

19. The system of claim 18, wherein the program further causes the at least one processor to receive payment from an advertiser for an achieved challenge and deliver a reward to a user completing a challenge.

20. The system of claim 13, wherein (e) comprises selectively provide advertisements to a publisher for transmission to each user.

21. The system of claim 20, wherein the program further causes the at least one processor to receive payment from an advertiser and make payment to one or more publishers to which transmission of an advertisement to each user is attributable.

22. The system of claim 13, wherein each target definition for an advertisement comprises one or more tuples, each tuple comprising a sensor profile tag defining an attribute of the user and probability data indicating a desired accuracy of the sensor profile tag.

23. The system of claim 13, wherein the passively collected sensor-detected offline behavior data is received from an environmental sensor or a biometric sensor.

24. The system of claim 13, wherein the passively collected sensor-detected offline behavior data is received from a pedometer, a heart rate monitor, a glucometer, a blood pressure monitor, a respiration sensor, a blood oxymeter, a spirometer, a thermometer, an accelerometer, a weight scale, an activity monitor, an electrocardiogram, an electroencephalogram, a motion detector, a thermostat, a switch sensor, a light detector, a microphone, a gas sensor, a barometer, a hygrometer, a current sensor, a water use meter, a gas use meter, a flow meter, an altimeter, a magnetometer, a glass break detector, a contact closure detector, a bed use detector, enuresis sensor, a fall detector, a medication dosing sensor, a water sensor, a smoke sensor, a property exit sensor, a CO sensor, a personal emergency response sensor, or a usage sensor.

25. A computer program product for targeted advertising based on passively collected sensor-detected offline behavior, said computer program product residing on a non-transitory computer readable medium having a plurality of instructions stored thereon which, when executed by a computer processor, cause that computer processor to:
(a) store a plurality of advertisements and a target definition associated with each advertisement in a data store;
(b) receive over a network passively collected sensor-detected offline behavior data for each of a plurality of users;
(c) generate a sensor profile of each user based on received passively collected sensor-detected offline behavior data for the user;
(d) select an advertisement from the plurality of advertisements for each user based on the sensor profile of the user and the target definition of the advertisement; and
(e) deliver a selected advertisement to each user over a network.
